(19) United States
(12) Patent Application Publication
(10) Pub. No.: US 2017/0357801 A1
(43) Pub. Date: Dec. 14, 2017

(54) ISOLATION SYSTEM FOR CYBERSECURITY

(71) Applicant: JPS Engineering Corp., San Diego, CA (US)

(72) Inventor: Jorge Sanchez, San Diego, CA (US)

(21) Appl. No.: 15/619,099

(22) Filed: Jun. 9, 2017

Related U.S. Application Data
(60) Provisional application No. 62/347,998, filed on Jun. 9, 2016.

(51) Int. Cl. G06F 21/53; G06F 21/56; G06F 21/60; G06F 21/57; G06F 21/72

(52) U.S. Cl. CPC G06F 21/53; G06F 21/577; G06F 21/72; G06F 21/602; G06F 21/566; G06F 2221/033

(57) ABSTRACT

The disclosed embodiments provide a method and apparatus for protecting a critical computer system from malware intrusions. An isolator containing access approval features is disclosed. The isolator requires the approval of a Supervisor which can be a person with authority or an intelligent computer before a user can have access to the critical computer system. The isolator contains features used to facilitate cascaded encryption and decryption of messages which further enhances the security of the critical computer system. The isolator can greatly improve security of infrastructure such as industrial control systems, servers and workstations.

### CROSS-REFERENCE TO RELATED APPLICATION

This application is a utility conversion of U.S. Provisional Application No. 62/347,998, filed Jun. 9, 2016, titled Integrated Circuit for Cybersecurity Protection which is hereby incorporated to this application in its entirety by reference.

### FIELD

The presently disclosed embodiments relate to a system containing various features used to isolate a computer or a computer system from external sources of malware that can cause damage and malfunction of the computer system. In this specification we will refer to malware as a computer virus, any type of hostile or intrusive software, worms, Trojan horses, ransomware, spyware, adware, scareware, and other malicious computer programs.

### BACKGROUND

There are presently several means for protection to keep malware from entering computer systems. Current state of the art solutions use multiple software means and approaches to protect the computer systems against cyber-attacks and malicious intrusions. The software used, although beneficial in some cases can be corrupted and rendered ineffective whenever cyber intruders discover a new method to confuse the software by exploiting seemingly endless possible points of attack.

FIG. 1 shows a computer system 100 which includes CPU hardware 101, with interfaces 102, disk drive 103, wireless interface 104, a USB port 105, and a keyboard interface function 106. The computer system operates under the control of an operating system software 107 which can be Windows, Linux, or other. The operating system manages the resources of the computer system. There can be a set of applications 108 installed in the computer system such as a word processor, a database management system, or a scientific program to predict the weather. Variation of this type of computer system architecture are used as servers to provide information to internet users, or for workstations. In the illustration of FIG. 1 we show the computer system interface connected to a set of machines 109, which in this example are used to control infrastructure. An example of infrastructure system is an electricity generating plant or the water management system for a city. Computer systems of this type are known as industrial control systems. The computer system uses an input/output (I/O) port 110 with logic functions to enable the computer system to communicate via a network connection 111 to an Interface 112 consisting of a router or a network controller that manages the communication of the computer system and multiple devices within a network and to the Internet 113. The Interface also allows other systems represented by the block 114 to access the internet using the connection 115. Connections 111 and 115 may conform to certain standards such as Ethernet.

Users of computer systems benefit greatly from modern operating systems and easy to use icons which launch applications with a double click of a mouse. This function eliminated the need to type commands to a computer to start an application or perform a given function. In a similar way there are many functions that work in the background of a computer where the user is generally unaware of the execution of those functions by the operating system. Operating systems have greatly increased the productivity of users and improved the ease of use. At the same time, browser application programs like Chrome and Explorer have greatly enhanced the capability to access information on the World Wide Web. With all of this convenience comes the risk of contracting malware which in the case of servers and industrial control systems a malware attack can make the machinery malfunction with serious consequences measured in financial losses and in endangering lives.

FIG. 1 shows the different points of weakness where malware can penetrate the computer system. An area of vulnerability is the various peripheral components of the computer such as the disk drive 103, wireless connections 104, USB ports 105 and the keyboard 106. The figure illustrates the malware infection 116 entering through those components. For example an infected disk 103 can be inserted into the computer system, or a wireless connection brings in a virus, an operator can connect an infected USB memory module, and a disgruntled operator may introduce a malfunction using the keyboard. Other systems represented at 114 in the network which are controlled by the interface 112 may also be infected from malware 118. Also, the user can access malicious websites which can bring in malware 119 over the internet 113.

When the malware penetrates a computer system it activates itself as an executable program. The operating system allows many executable programs to be active at any one time. To appreciate this, if we type control-alt-delete on a keyboard simultaneously and by selecting the task manager in a windows operating system a window will appear listing the multiplicity of currently active operations. This happens because windows is a multitasking system. Often, malware disguises itself as a legitimate program and begins to perform its invasion of the computer system and over time it takes over the management and operation in order to further its malicious objectives.

The operating system 107 in the computer system 100 will be typically equipped with an antimalware program 120. Even in the best of systems due to the number of possible points of entry and due to the large number of people worldwide with malicious intent eventually malware shown at 121 may get into a computer system. This situation will create havoc until a suitable fix known as an antimalware program 120 is found and the system is cleaned of problems. However, there is a delay of time between the infection getting into the computer system and when a software antidote is found which causes damage to the data and infrastructure the computer system manages. Malware in some cases is so damaging that it will even infect the antimalware programs rendering ineffective, it can also encrypt the data in the computer system subsequently sending a ransom demand to the computer owner before the decryption key is provided. In many cases there is a complete loss of the information which can cause substantial losses. As mentioned, in the case of the industrial control systems consequences can be fatal.

In summary, current computer systems exhibit numerous points of vulnerability, antimalware must constantly be changed under extremely urgent conditions to come up with an antidote to an attack, attacks are generally undetected until after damage is caused somewhere in computer systems, IT workers operating as analysts must keep constant vigilance of computer systems to detect malware resulting in high operating costs, internal and external operators can introduce malware and cause damage.

### SUMMARY

Unlike protection approaches that rely only on software, the protection solution presented in this invention consists of a combination of hardware and software used to isolate the computer system from the points of entrance of malware. The solution is arranged in an isolator system. Because the isolator makes extensive use of hardware, it is not confused by malware since it will do only what it is hardwired to do and only that thus ignoring any malware software attempts to perform other malicious functions.

### BRIEF DESCRIPTION OF THE DRAWINGS

The nature, objects, and advantages of the invention will be clarified with the following detailed description in connection with the accompanying drawings:

FIG. 1 shows a computer system highlighting its vulnerabilities to malware;

FIG. 2 illustrates the isolator which is the purpose of this invention

FIG. 3 illustrates in detail the features of the isolator

FIG. 3a shows an embodiment of the multi-port interface and the gatekeeper timer logic circuits

FIG. 4 illustrates an application of the isolator to safeguard a critical computer system

FIG. 5 is a flowchart of the security process

### DETAILED DESCRIPTION

Any embodiment described herein as an example is not necessarily to be construed as preferred or advantageous over other possible embodiments and arrangements for the use of the isolator.

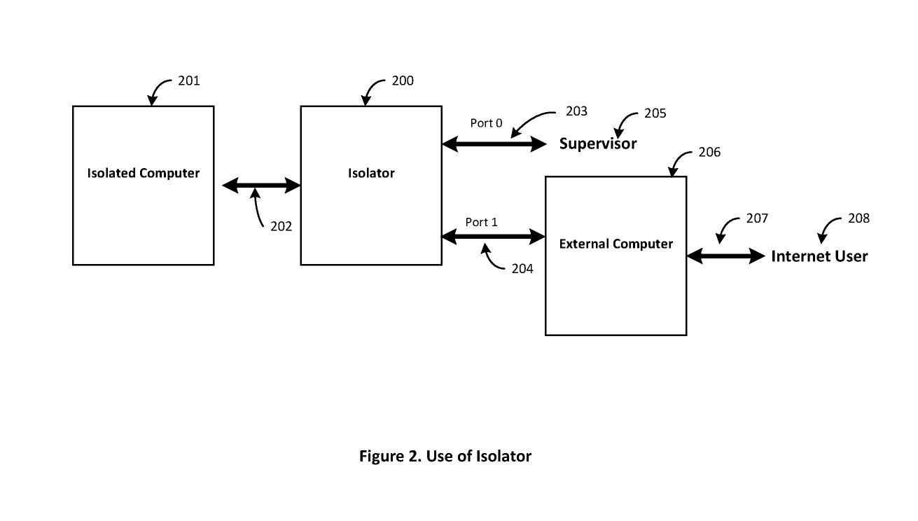

One implementation of a system using the isolator is presented in FIG. 2. The isolator 200 is connected to the computer system to be protected, designated the isolated computer 201 in FIG. 2, by means of an interface connection 202. The isolator has two ports: Port 0 shown as item 203 in the figure, and Port 1 corresponding to 204 in the figure. In this embodiment, Port 1 is connected to a computer which is outside of the area protected by the isolator, named here the external computer 206. The external computer may use interface connection 207 to connect to the internet at 208. In a given application of the isolator, an individual internet user of the external computer may request access to the isolated computer using Port 1 for the purpose of loading an application, to make an update or to manage a change of the operation of a system controlled by the isolated computer. When the access request is detected by the isolator, as part of the vetting process, the isolator verifies the credentials of the user 208. At the same time, an internal timer is triggered to limit the window of time when the access can be approved. A required condition to grant access to the Internet user 208 is that another individual with the appropriate credentials, called in this case the Supervisor 205 is connected to Port 0. The Supervisor is defined as another individual who has a position of authority in the computer installation such as an IT manager or a power plant manager who is ultimately responsible for the correct and safe operation of the computer infrastructure. The Supervisor 205 must provide its own access credentials and if this happens, the isolator approves the access of the user 208 to enter the isolated computer and effect changes. If the Supervisor 205 does not log into the system within a predetermined period of time, or gives the incorrect credentials, the isolator terminates both connections and internally logs the attempt to access for security tracking purposes. The credentials of the user 305 and the Supervisor 205 may be changed periodically to enhance the security. With this feature the probability that an intruder has acquired credentials for both the user 208 and the Supervisor 205 is reduced. As described below, parts of the isolator 200 may be implemented in hardware to increase security.

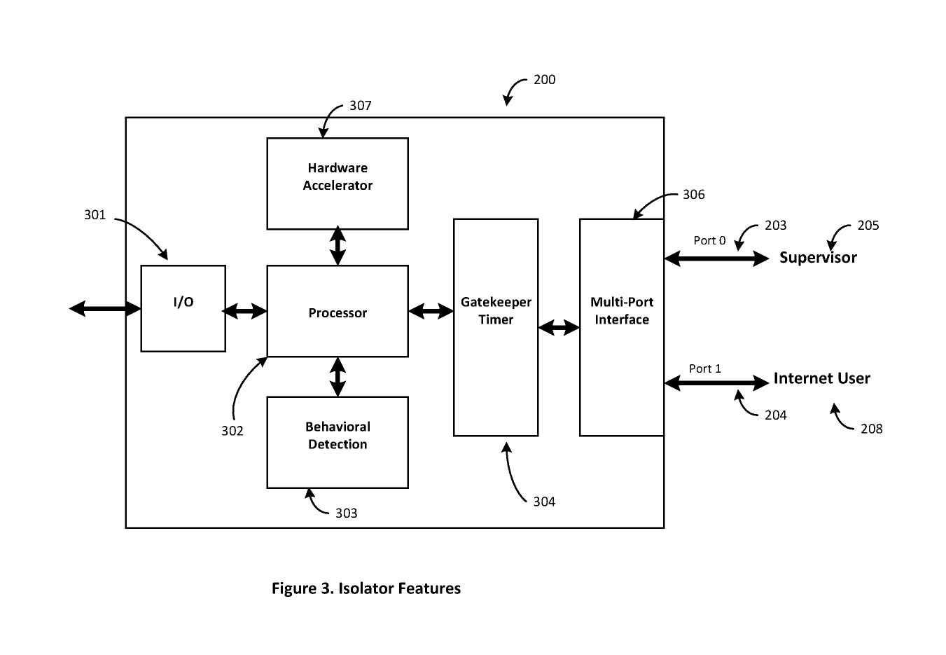

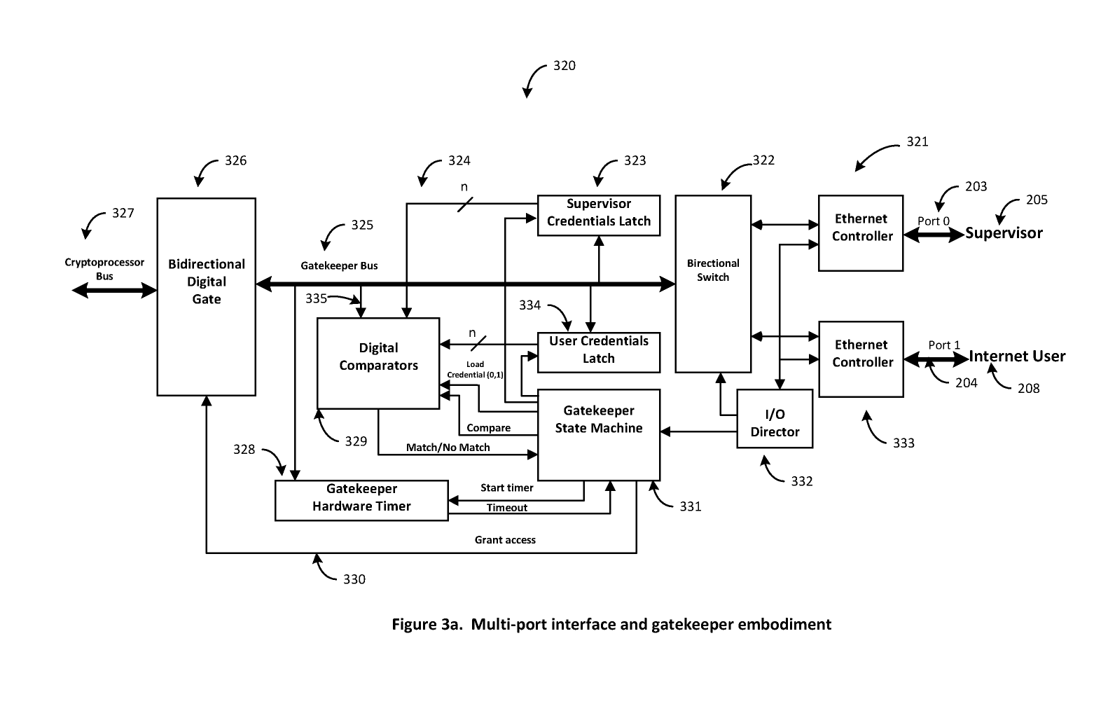

FIG. 3 illustrates an implementation of features of the isolator. Isolator 200 connects to the isolated computer 201 by means of an input output logic circuit (I/O) 301. The opposite side of the isolator contains a multi-port interface 306 which allows connection to a Supervisor 205 by means of Port 0 connection at 203. Also, an internet user 305 connects to the isolator using Port 1 at 204. The multi-port interface 306 contains the logic necessary to implement the protocol used to connect to the internet user 305 and the Supervisor 205. An example of this protocol is an Ethernet connection. The gatekeeper timer 304 determines the time window within which the isolator can accept access. This unit contains a timer that may be programmable at the time when the isolator is installed. One element of the isolator may be a Processor 302. This portion of the isolator enhances the usefulness of the isolator by carrying out CPU operations needed to detect malware with conventional antimalware software. For this purpose, the Processor may create a sandboxed environment to quarantine and observe the behavior of a given file or program that is intended to be given access to the isolated computer. This can be useful in industrial control systems where is it desirable at times to install an update in the computer system that directs the operation of the industrial control computer such as in a power plant. The operator in this example can be an Internet User 305 such as a computer programmer in the organization who remotely wishes to make a change in the operation of the power plant. The change in operation may be an executable program or a file with instructions. The processor 302 and the behavioral detection block of logic 303 may evaluate the lines of software first before allowing entry into the isolated computer 201. It is possible to also include bypass functionality so that the software instructions can be sent from the gatekeeper timer 304 directly to the isolated computer 201 without evaluation. This may be used in situations where the source of the software is trusted and the software has been previously scrutinized. The Processor 302 can be implemented as a Cryptoprocessor. This is a type of processor where the internal instruction set of the CPU is encrypted in various ways so that it is very difficult to determine what logical sequences of operations the CPU is conducting. There have been many types of Cryptoprocessors built in the past with varying degrees of security, which is dependent on the level of sophistication of the encrypted internal microinstructions of the CPU. Many implementations scramble the logic and the microinstructions in a way that the entire operation is convoluted and is very difficult to determine what the CPU is doing even while monitoring its internal circuits as is known to be done by industrial espionage activities. Its precise operation is only apparent to the designer of the CPU. Others would find it very difficult to discern the operation. The instruction set of the Cryptoprocessor can also be periodically changed so that it is always a step ahead of people with malicious intent. In some embodiments, this may be facilitated by implementing at least some processor functionality with a Field Programmable Gate Array (FPGA).

Another facility that may be contained in the isolator is the hardware accelerator 307. This block of logic may contain hardware multipliers, shifting functions, matrix manipulations and other functions used in encryption. The objective of this function of the isolator 200 is to enable the isolated computer 201 to be able to communicate with external computers using encrypted messages and encrypted data. In this manner, we are able to intensify the level of security since only valid encrypted messages or data can be accepted by the Processor 302. In addition, because we have the assistance of the hardware accelerator 307 it becomes practical to use cascaded encryption. This type of encryption is used when encryption is used on an already encrypted message. This process can be carried our multiple times. Often the issue with cascaded encryption is that it takes a long time to decrypt or encrypt a message. However with an accelerator, the speed at which encryption or decryption is done is substantially reduced. The isolator may be implemented in a set of logic circuits, a Field Programmable Gate Array or in a custom integrated circuit.

In reference to FIG. 3a a possible embodiment for the multi-port interface and the gatekeeper logic is shown. The diagram shows how the Supervisor input 205 applies its approval input to an Ethernet controller 321 using Port 0 at 203 and the Internet user 305 applies its request for entry into the system to Ethernet controller 333 using Port 1 at 204. In this case we show a two port system, however the isolator can be implemented with a one port system with appropriate modifications of the interface. The outputs from both Ethernet controllers are connected to a bidirectional logic switch 322. The protocol and management of the Ethernet controllers is done by the I/O Director 332. This unit could be implemented with a microcontroller with firmware. A state machine is a control unit that where a set of outputs are a function of a set of inputs and a logic state. The state machine can perform complex operations which may be hardwired and is an ideal candidate for an FPGA implementation. The function of the I/O Director 332, since its operations are fairly focused, it is best to implement the function with a state machine because a state machine adds a higher level of security. This is because a state machine will only perform the operations it is meant to do and will ignore attempts by external software to make it do anything else or to modify its operation. The secondary side of the Bidirectional Switch leads to what is called the Gatekeeper Bus 325 which contains the gatekeeper functionality. The purpose of the gatekeeper is to determine if access to the system is granted to the external sources connected to Port 0 and Port1. Accordingly, the I/O Director 332 conducts the protocol needed to receive the credentials of the Supervisor 205 and the internet user 305 one at a time. Credentials are user name, password and other pin identifier. Each time a credential is routed by the I/O Director to the Gatekeeper Bus, a signal is sent to the Gatekeeper State Machine 331. This block controls all functions needed to authenticate the sources requesting entrance to the system and as its name suggests it is implemented with hardwired logic. Once the I/O Director 333 allows entry to the Internet User its credentials are stored in the User Credential Latch 334. Thereafter the I/O Director will route instead the Supervisor 205 access credentials to the Supervisor Credentials Latch 323. When the credentials for access by the Internet User 305 are received, the Gatekeeper State Machine 331 starts the Gatekeeper Hardware Timer. The Supervisor 205 credentials must be received within a predetermined period of time hardwired into the timer. If the second set of credentials is not received, then the process is terminated and access request is ignored. The two sets of credentials latches contain n bits as shown in FIG. 3a. All of the bits are connected to the Digital Comparators 329 inputs. In the next state, the Gatekeeper State Machine enters internally into the next logic state and activates the Compare input to the Digital Comparators 329 block. The Digital Comparators is made with logic which compares bit by bit the credentials of the Supervisor 205 and the Internet User 305. There is a backdoor used to load new credentials into the Digital Comparators with the connection of the Gatekeeper Bus with the connection shown at 335 and with a unique command sent to the Gatekeeper State Machine 331 by the I/O Director 332 after a code is received from the Supervisor input 305. Once both sets of credentials are verified to be authentic, the Digital Comparators logic block 329 will sent a Match or No Match signal to the Gatekeeper State Machine 331. If there is a match, then the Gatekeeper State Machine will activate Grant Access control line 330 which enables the Bidirectional Digital Gate 326 to allow access to the Cryptoprocessor Bus 327. Is it to be noted that all of these transactions described above may be very fast since most or all of the operations are done with logic hardware and state machines and with a minimal set of sequential operations. There can be a multiplicity or implementations that can be obtained while maintaining the principle objectives of this invention.

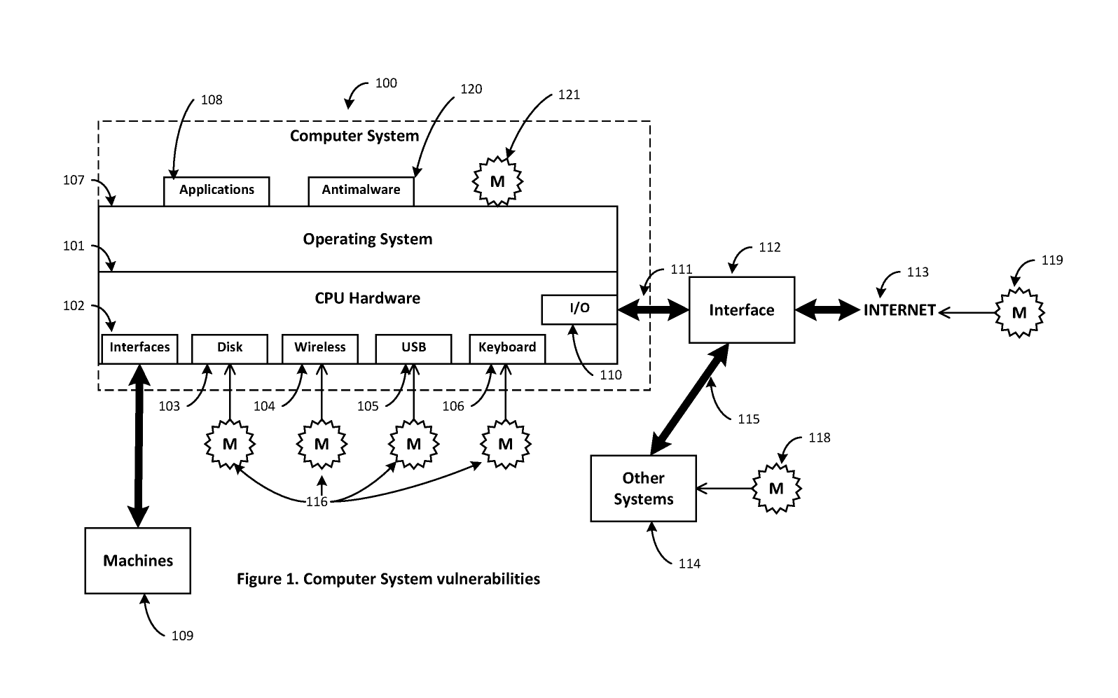

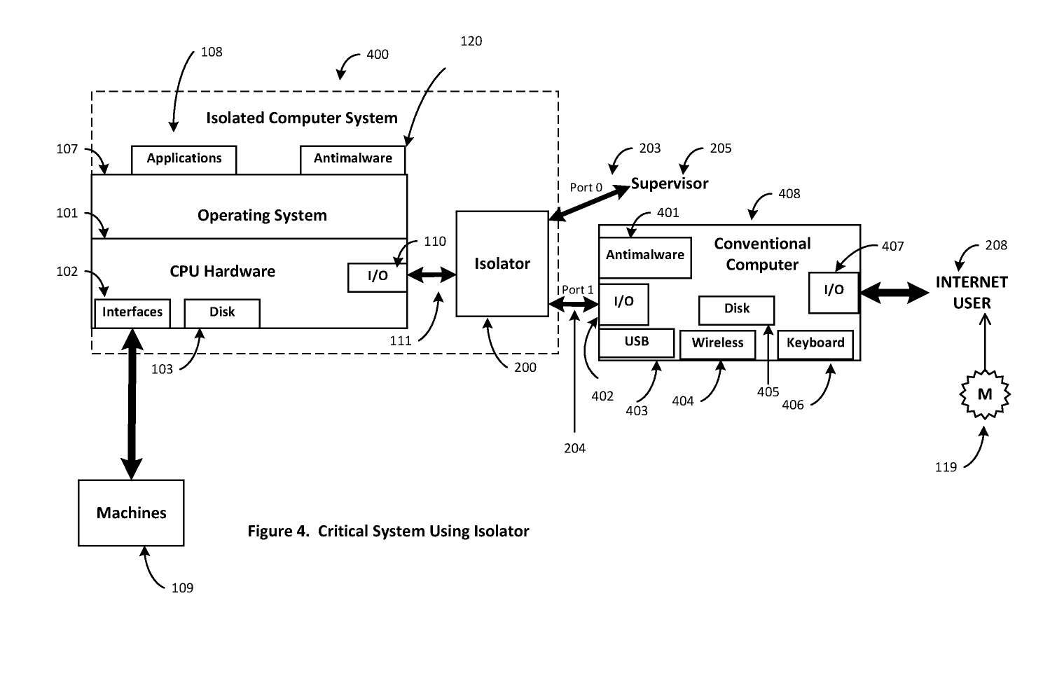

FIG. 4 is an embodiment showing an application of the isolator used to protect a critical system such as an industrial control system, a server, or a workstation. In this application we applied a suggested policy where we eliminate most of the potential area of malware intrusion which were shown in the computer system of FIG. 1. Therefore the disk 103 used is only the disk used with the system when first built or a new disk with verified software and data. There is no direct wireless interface or a USB port or a keyboard. The way to go in to the workings of the isolated computer system 400 is to go through the isolator. In the isolated computer system 400 we still include connection to machines 109 for various purposes such as an industrial control system, we also will include the necessary applications 108, antimalware 120 and an I/O port 110. As described previously a Supervisor 205 monitors and approves access to the computer though Port 0 at 203. An internet user 208 will have access to the isolated computer system with a conventional computer containing previously described features such as an I/O 402, wireless interface 404, a disk 405 an keyboard 406, and I/O 5407 used to connect to the internet. The I/O 407 may be an Ethernet connection or another protocol. In addition, the conventional computer 408 will also include an antimalware program 401. In this arrangement if a malware attack represented by 119 would have to go through more than one source of filters and will be prevented from entering the isolated computer system by the isolator 200. Even if the conventional computer 408 becomes infected with malware, it is possible to format the disk of this computer, reinstall the operating system and the applications. However, the isolated computer system 400 which operates critical infrastructure will not be affected.

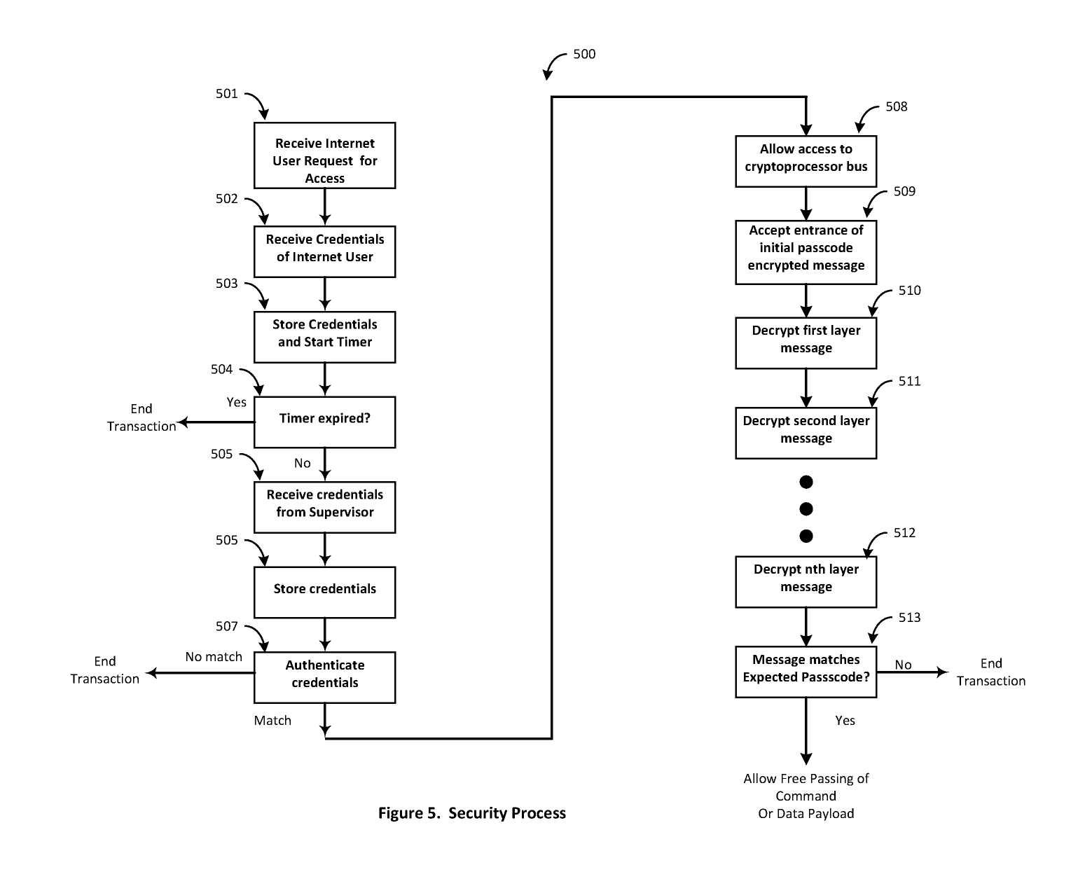

The Security and authentication process can be best appreciated with the aid of the flowchart in FIG. 5. At 501 we show the step where the request for access from the Internet User 208 is received. In the next step at 502 the access credentials of the Internet User 208 are received and passed on to the Gatekeeper Bus 325 by the hardware in the I/O Director 332, the Gatekeeper State Machine 331 then proceeds to store the credentials of the Internet User 208 in the User Credential latch 334 and start the Gatekeeper Hardware Timer 328. At 504 if the timer expires the Gatekeeper State Machine 331 receives a Timeout signal and the transaction is terminated. If the Supervisor 205 credentials are received before the timer expires then its credentials are passed on to the Gatekeeper Bus 325 and are stored in the Supervisor Credentials Latch 323 triggered by an action taken by the Gatekeeper State Machine 331. In step 507 the Gatekeeper State Machine 331 proceeds to command the Digital Comparators to compare the credentials with previously stored credentials to authenticate both the request from the Internet User 208 and the Supervisor 205. If both credentials do not match, the transaction is terminated. If the credentials are authenticated, then the Gatekeeper State Machine 331 allows access to the Cryptoprocessor Bus 327 by enabling a gate in the Bidirectional Digital Gate 326. This step is shown at 508.

We then follow the security process with a secondary optional process where an encrypted secret message is sent by the Internet User 208 who wants access to the computer system. The secret message is decrypted at the Processor 302 and if the decrypted message matches a previously stored secret message stored in the Processor 302 then authentication is determined to be positive. The encrypted secret message can be any message such as a long sentence or a chosen passage of a book.

For a higher level of security, the encrypted secret message may be encrypted in multiple layers of encryption at the Internet User's computer with multilayer encryption. This is done with a set of encryption keys that match decryption keys stored in the Processor 325 memory which are used to decrypt the message received. Multilayer encryption is a process whereby a first message is encrypted, then a second encryption is done on the results with a second encryption key. The processes is repeated multiple times each time with a different encryption key. The encryption keys and the encrypted message are stored in the semi-permanent memory of Processor 302. Normally multiple encryption is time consuming and is not used as much because of time delays. In our case we have added a Hardware Accelerator 307 which facilitates the operations. The Hardware Accelerator 307 can contain logic to allow multiple operations to be conducted fast. For an example of the types of operations that can be handled in hardware to allow fast encryption and decryption see the publication of the National Institute of Standards and Technology in this link: http://nvlpubs.nist.gov/nistpubs/FIPS/NIST.FIPS.197.pdf In the specific situation of the AES 256 algorithm the same key is used for encryption and decryption thus the reason why the AES 256 algorithm is called ‘symmetric”. To this day the AES 256 algorithms is considered virtually unbreakable and the only documented ways in which this algorithm has been hacked is with the use of partial information obtained from the users of a computer system.

If we choose the secondary security process then the system will decrypt the first layer of the message at 510, then the second layer at 511 and so on until all the cascaded n encryption layers have been decrypted at 512. At this point if the secret encrypted message matches what our Processor 302 contains in its memory at step 513 then we can be confident of the authenticity of the sources requesting access otherwise the transaction is ended. If authenticity is verified then passage of a payload of data and or commands is allowed from the Internet User 208 to the Isolated Computer.

It is to be noted that the Processor 302 can be implemented as a class of processors known as Cryptoprocessors where the internal operations and the instruction set of the processor are themselves encrypted. Also the substantial reliance on logic hardware and state machines serves to increase security since Malware software and related attacks will have difficulty in accessing the system as hardware can only act in the way it was wired to perform a given function. The second process of decoding an encrypted message to compare it with a previously stored message adds a substantial amount of security which is of key importance in critical installations especially in the case of industrial control systems for infrastructure such as power plants water management systems, dams, server farms and networks.

The previous description of the disclosed embodiments is provided to enable the construction and use of the present invention. The isolator can be installed in a variety of architectural configurations. Various modifications to these embodiments are possible and within the scope of the invention.

1. A security circuit for isolating a computer, the security circuit comprising:
one or more I/O ports for access to the security circuit by a user and a supervisor;
a timer;
a logic circuit configured (1) to detect access of the circuit by a user and access of the circuit by a supervisor though the one or more I/O ports, (2) to monitor the time between the respective accesses with the timer, and (3) to remove a barrier to accessing the isolated computer when the respective accesses occur within a threshold time.

2. The security circuit of claim 1, wherein the logic circuit is further configured to assess security credentials received by the security circuit via the one or more I/O ports.

3. The security circuit of claim 1, wherein the logic circuit is implemented at least in part as a hardware finite state machine.

4. The security circuit of claim 1, wherein the logic circuit is implemented at least in part with a field programmable gate array (FPGA).

5. The security circuit of claim 1 wherein the timer is implemented in a FPGA.

6. The security circuit of claim 3, wherein the timer is implemented in a FPGA.

7. The security circuit of claim 4, wherein the timer is implemented in a FPGA.

8. The security circuit of claim 1, wherein the logic circuit is implemented at least in part in a firmware programmed microcontroller.

9. The security circuit of claim 1, additionally comprising a microprocessor core.

10. A security circuit for isolating a computer, the security circuit comprising:
one or more I/O ports;
a first bus;
a bidirectional switch coupled between the one or more I/O ports and the first bus;
a second bus;
a bidirectional gate coupled between the first bus and the second bus;
a microprocessor core coupled to the second bus;
a hardware state machine coupled to the bidirectional gate configured to block or allow data transfer between the first bus and the second bus.

11. The security circuit of claim 10, comprising an I/O port coupled to the microprocessor core.

12. The security circuit of claim 11, comprising a cryptographic hardware accelerator coupled to the microprocessor core.

13. The security circuit of claim 10, wherein the microprocessor core is configured to test behavior of software transferred to the microprocessor through the bidirectional gate.

14. An isolation system comprising:
a first layer of protection based on two sets of credentials allowing an encrypted message to pass from a user to a processor;
second layer of protection based on decryption of the encrypted message by the processor.

15. The isolation system of claim 15 comprising a cryptographic hardware accelerator coupled to the processor. where the secondary protection consists of a set of cascaded encryption messages

16. The isolation system of claim 15, wherein the first layer of protection comprises a logic circuit comprising a hardware finite state machine.

17. A method of isolating a computer comprising:
receiving an access request and access credentials from an internet connected user;
starting a timer;
storing the access credentials of the user;
starting a timer;
receiving an access request and access credentials from a supervisor within a threshold time as measured by the timer;
storing the access credentials of the supervisor;
authenticating the user and supervisor credentials.

18. The method of claim 17, comprising allowing access to a processor bus by the user in response to the authentication.

19. The method of claim 18, comprising decrypting a message from the user with the processor.
